(19) United States
(12) Patent Application Publication
(10) Pub. No.: US 2024/0263723 A1
(43) Pub. Date: Aug. 8, 2024

(54) REFRIGERANT-TRANSPORTING HOSE

(71) Applicant: THE YOKOHAMA RUBBER CO., LTD., HIRATSUKA-SHI, KANAGAWA (JP)

(72) Inventors: Kenta WAKABAYASHI, HIRATSUKA SHI, KANAGAWA (JP); Shun SATO, HIRATSUKA SHI, KANAGAWA (JP); Tomohide SAITA, HIRATSUKA SHI, KANAGAWA (JP)

(21) Appl. No.: 18/580,757

(22) PCT Filed: Jul. 8, 2022
(86) PCT No.: PCT/JP2022/027057

§ 371 Date: Jan. 19, 2024

(30) Foreign Application Priority Data
Jul. 29, 2021 (JP) 2021-124601
Oct. 1, 2021 (JP) 2021-162526

(51) Int. Cl. F16L 11/08; B32B 1/08; B32B 7/12; B32B 27/32; B32B 27/34

(52) U.S. Cl. CPC F16L 11/08; B32B 1/08; B32B 7/12; B32B 27/32; B32B 27/34; B32B 2250/03; B32B 2307/54; B32B 2307/558; B32B 2307/7246; B32B 2597/00

(57) ABSTRACT

Provided is a refrigerant-transporting hose having a low gas permeability of steam, fluorocarbons, or the like, and being flexible and light-weight. The refrigerant-transporting hose includes at least an outer layer, a reinforcing layer, and an inner layer. The outer layer has a layer composed of a thermoplastic resin composition A, and the inner layer has a layer composed of a thermoplastic resin composition B. The thermoplastic resin composition A has a sea-island structure in which a thermoplastic resin a containing a polyolefin resin serves as the matrix and from 51 to 85 mass % of an elastomer a containing a butyl elastomer serves as the domains. The thermoplastic resin composition B has a sea-island structure in which a thermoplastic resin b containing a polyamide resin serves as the matrix and an elastomer b containing a butyl elastomer serves as the domains.

### TECHNICAL FIELD

The present invention relates to a refrigerant-transporting hose to be used in an air conditioner in an automobile.

### BACKGROUND ART

Reducing the weight of automobiles has become one of the important challenges for complying with carbon dioxide emission regulations. As such, refrigerant-transporting hoses to be used in an air conditioner or the like installed in an automobile are also required to have a reduced weight. Thinning the inner layer or the outer layer constituting a hose for the purpose of weight reduction may result in deterioration in gas permeability of a refrigerant to be transported, and/or oxygen, steam, or the like. In response to that, some proposals substitute rubber, which is a constituent material of inner layer, with a polyamide resin composition having excellent gas permeability (see, for example, Patent Documents 1 and 2).

Refrigerant-transporting hoses are installed in limited, narrow spaces in automobiles, such as air conditioners. As such, excellent flexibility and easy installation even in narrow spaces are required for refrigerant-transporting hoses. Further, refrigerant-transporting hoses are required to have durability that allows the refrigerant-transporting hoses to withstand use for a long period of time in the high-temperature and high-humidity environment inside an engine room. However, the resin hose according to Patent Document 1 and the refrigerant-transporting pipe according to Patent Document 2 are composed of a polyamide resin composition. As such, steam permeability with respect to moisture on the outside of the hose is concerning, and gas permeability may deteriorate due to moisture absorption of the polyamide resin composition. Therefore, there is room for improvement in obtaining a refrigerant-transporting hose that has a reduced permeability of refrigerant to be transported and a reduced steam permeability of moisture on the outside of the hose while being light-weight and having excellent flexibility.

### CITATION LIST

### Patent Document

Patent Document 1: JP 2013-155793 A
Patent Document 2: JP 2021-46490 A

### SUMMARY OF INVENTION

### Technical Problem

An object of the present invention is to provide a refrigerant-transporting hose that has a low gas permeability of a refrigerant, steam, or the like, and that is flexible and light-weight.

### Solution to Problem

The refrigerant-transporting hose according to the present invention to achieve the above object includes at least an outer layer, a reinforcing layer, and an inner layer. The outer layer includes at least a layer composed of a thermoplastic resin composition A, and the inner layer includes at least a layer composed of a thermoplastic resin composition B. The thermoplastic resin composition A has a sea-island structure in which a thermoplastic resin a serves as a matrix and an elastomer a serves as domains, the thermoplastic resin a containing at least a polyolefin resin and the elastomer a containing at least a butyl elastomer, the elastomer a being from 51 to 85 mass % in 100 mass % of the thermoplastic resin composition A. The thermoplastic resin composition B has a sea-island structure in which a thermoplastic resin b serves as a matrix and an elastomer b serves as domains, the thermoplastic resin b containing at least a polyamide resin, and the elastomer b containing at least a butyl elastomer.

### Advantageous Effects of Invention

The outer layer of the refrigerant-transporting hose according to the present invention includes a layer composed of the thermoplastic resin composition A containing a polyolefin resin, and thus the steam permeability of moisture on the outside of the hose can be reduced. Furthermore, the inner layer of the refrigerant-transporting hose according to the present invention includes a layer composed of the thermoplastic resin composition B containing a polyamide resin, and thus the permeability of a refrigerant to be transported can be reduced. Further, the weight of the hose can be reduced because the outer layer having excellent, reduced steam permeability can be made thin and the inner layer having excellent, reduced permeability of refrigerant can be made thin. In addition, the thermoplastic resin composition A and the thermoplastic resin composition B have a sea-island structure in which a butyl elastomer serves as the domains, resulting in excellent flexibility of the hose.

In the refrigerant-transporting hose, the elastomer b is preferably from 51 to 85 mass % in 100 mass % of the thermoplastic resin composition B, for this allows the hose to be made more flexible. The refrigerant-transporting hose preferably does not include a layer composed of vulcanized rubber, for this allows the productivity of the refrigerant-transporting hose to be improved.

The fluorocarbon permeability coefficient of the thermoplastic resin composition B is preferably smaller than the fluorocarbon permeability coefficient of the thermoplastic resin composition A, for this allows the permeability of fluorocarbons transported by the hose to be efficiently reduced and the occurrence of blisters to be suppressed. Meanwhile, the steam permeability coefficient of the thermoplastic resin composition A is preferably smaller than the steam permeability coefficient of the thermoplastic resin composition B, for this can suppress the permeation and diffusion of moisture from the outside of the hose, prevent moisture absorption by the inner layer containing a polyamide resin, and maintain a low permeability of fluorocarbons.

In the thermoplastic resin composition A, the thermoplastic resin a preferably contains at least a polypropylene resin and the elastomer a preferably contains at least a halogenated butyl rubber, for this can give the hose excellent flexibility while further reducing the permeability of moisture from the outside of the hose. Further, in the thermoplastic resin composition B, the thermoplastic resin b preferably contains at least a polyamide 6 resin and the elastomer b preferably contains at least a halogenated isobutylene-paramethylstyrene copolymer rubber, for this can give the hose excellent flexibility while further reducing the permeability of a refrigerant to be transported. Moreover, a part of the domains of the thermoplastic resin composition A and/or a part of the domains of the thermoplastic resin composition B is preferably crosslinked, for this can increase the durability of the outer layer and/or the inner layer.

In the refrigerant-transporting hose, a water-based adhesive, a solvent-based adhesive, a chemical reaction adhesive, or a hot-melt adhesive is preferably interposed between the outer layer and the reinforcing layer and/or between the inner layer and the reinforcing layer, for this can further increase the durability of the hose.

The thermoplastic resin composition A preferably has a melt viscosity of 1000 Pa·s or less at 250° C. and a shear rate of 243.2 s⁻¹, for this can improve extrudability when forming the outer layer. The thermoplastic resin a preferably contains one or more types of thermoplastic resins having a melting point of 150° C. or higher while the thermoplastic resin b preferably contains one or more types of thermoplastic resins having a melting point of 200° C. or higher, for this can give a satisfactory processability when extrusion-molding the outer layer at the outer circumference of the extrusion-molded inner layer.

The thermoplastic resin composition A preferably has a tensile stress at 10% deformation of 10 MPa or less and a steam permeability coefficient of 3.0 g·mm/(m²·24 h) or less, for this can give the outer layer both low steam permeability and flexibility at a high level. Further, the thermoplastic resin composition B preferably has a tensile stress at 10% deformation of 10 MPa or less and an oxygen permeability coefficient of 0.05 cm³·mm/(m²·day·mmHg) or less, for this can give the inner layer both low permeability of refrigerant and flexibility at a high level.

The thermoplastic resin composition A preferably has a tensile strength at break at 23° C. of 3 MPa or greater and a tensile elongation at break of 200% or greater, for this can ensure the durability of the outer layer at room temperature or normal temperature. Further, the thermoplastic resin composition A preferably has a tensile strength at break at 150° C. of 0.4 MPa or greater and a tensile elongation at break at 150° C. of 50% or greater, for this can ensure the durability of the outer layer at high temperatures. Furthermore, the thermoplastic resin composition A and the thermoplastic resin composition B preferably have a non-broken Izod impact strength at −40° C., for this can ensure the durability of the outer layer and the inner layer at low temperatures.

### BRIEF DESCRIPTION OF DRAWINGS

FIG. 1 is an explanatory diagram illustrating a cross-section of a refrigerant-transporting hose according to the present invention.

FIG. 2 is an explanatory diagram illustrating a measurement method of the flexibility of a hose.

### DESCRIPTION OF EMBODIMENTS

A refrigerant-transporting hose according to the present invention refers to a hose that is for transporting a refrigerant and that is to be used in an air conditioner or the like of an automobile. Examples of the refrigerant include a hydrofluorocarbon (HFC), a hydrofluoroolefin (HFO), a hydrocarbon compound, carbon dioxide, ammonia, and water. Examples of the HFC include R410A, R32, R404A, R407C, R507A, and R134a. Meanwhile, examples of the HFO include R1234yf, R1234ze, R1233zd, R1123, R1224yd, and R1336mzz. Examples of the hydrocarbon compound include methane, ethane, propane, propylene, butane, isobutane, pentane, heptafluoropropane, and hexafluoropropane.

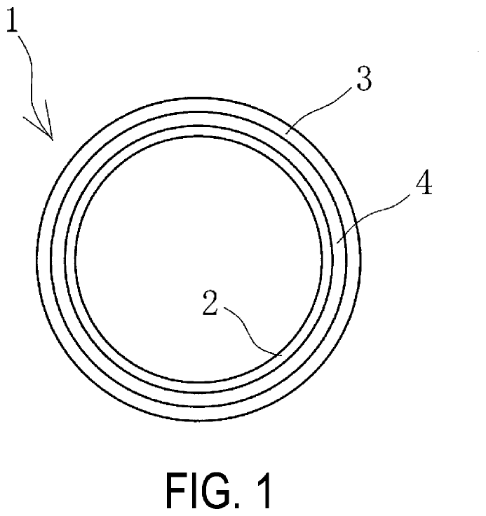

FIG. 1 is an explanatory diagram illustrating a cross-section of the refrigerant-transporting hose according to the present invention. A refrigerant-transporting hose 1 includes at least an outer layer 3, a reinforcing layer 4, and an inner layer 2, the outer layer 3 being disposed on the outer circumferential side of the reinforcing layer 4 while the inner layer 2 being disposed on the inner circumferential side of the reinforcing layer 4. The outer layer 3 and the inner layer 2 are each configured to have a circular tube shape. Further, a plurality of the reinforcing layers 4 may be provided, in which case the inner layer 2 is disposed on the inner circumferential side of the reinforcing layer 4 that is on the innermost side while the outer layer 3 is disposed on the outer circumferential side of the reinforcing layer 4 that is on the outermost side. Examples of a layer in addition to the outer layer 3, the reinforcing layer 4, and the inner layer 2 include an adhesive layer, a barrier layer, and a rubber layer. The adhesive layer may be interposed between the outer layer 3 and the reinforcing layer 4 and/or between the inner layer 2 and the reinforcing layer 4.

The outer layer 3 of the refrigerant-transporting hose has at least a layer composed of a thermoplastic resin composition A, and may have a layer in addition to the layer composed of the thermoplastic resin composition A on the inner circumferential side and/or the outer circumferential side of the outer layer 3. The properties of the layer in addition to the layer composed of the thermoplastic resin composition A are not limited as long as the object of the present invention is not impaired.

The inner layer 2 of the refrigerant-transporting hose has at least a layer composed of a thermoplastic resin composition B, and may have a layer in addition to the layer composed of the thermoplastic resin composition B on the inner circumferential side and/or the outer circumferential side of the inner layer 2. The properties of the layer in addition to the layer composed of the thermoplastic resin composition B are not limited as long as the object of the present invention is not impaired.

The thermoplastic resin composition A constituting the outer layer has a sea-island structure in which a thermoplastic resin a serves as the matrix and an elastomer a serves as the domains. The sea-island structure refers to a dispersed form in which the matrix is the sea phase (continuous phase) and the domains are the island phase (discontinuous phase, dispersed phase). The shapes of the domains are not limited, and may be any of a spherical shape, an ellipsoidal shape, a cylindrical shape, an acicular shape, and an amorphous shape. Note that, the dispersed form of the thermoplastic resin composition A can be observed by a scanning probe microscope (SPM) or the like with respect to a vertical cross-section in the extrusion grain direction. The observation magnification can be appropriately determined according to the sizes of the domains.

The thermoplastic resin a contains at least a polyolefin resin. The thermoplastic resin a may be a polyolefin resin by itself or may be a blend with another thermoplastic resin. When the polyolefin resin is contained, the steam permeability can be reduced, resulting in excellent steam permeability. Examples of the polyolefin resin include a polyethylene resin, a polypropylene resin, and a polybutene resin. Among these, a polypropylene resin is preferred. When the thermoplastic resin a contains a polypropylene resin, both low steam permeability and heat resistance can be achieved in a compatible manner. Examples of the polypropylene resin include a propylene homopolymer, a propylene/ethylene block copolymer, a propylene/ethylene/1-butene block copolymer, a propylene/ethylene random copolymer, a propylene/1-butene random copolymer, a propylene/ethylene/1-butene random copolymer, a propylene/ethylene random block copolymer, and a propylene/ethylene/1-butene random block copolymer. Among them, a propylene homopolymer, a propylene/ethylene block copolymer, and a propylene/ethylene random copolymer are preferred. The polyolefin resin may contain at least a part of a modified polyolefin resin having a functional group such as a maleic acid anhydride group. Further, the polyolefin resin may be used alone or in a combination of a plurality thereof.

Examples of the other thermoplastic resin in addition to the polyolefin resin that can be contained in the thermoplastic resin a include a polyamide resin, a polyester resin, a polyvinyl alcohol resin, and a polyketone resin. One or more of these may be blended with the polyolefin resin. Note that, when the other thermoplastic resin is blended, the polyolefin resin may be 51 mass % or greater, preferably 60 mass % or greater, and more preferably 70 mass % or greater in 100 mass % of the thermoplastic resin a.

The thermoplastic resin a preferably contains one or more types of thermoplastic resins having a melting point of 150° C. or higher. When a thermoplastic resin having a melting point of 150° C. or higher is contained, the heat resistance necessary for the hose is improved. The melting point of the polyolefin resin and/or the other thermoplastic resin may be 150° C. or higher, preferably from 155 to 170° C., and more preferably from 162 to 170° C. Note that, in the present specification, the melting point of thermoplastic resin is obtained by measuring the temperature of an endothermic peak accompanying melting in a temperature rising process using a DSC method.

The thermoplastic resin a is preferably from 15 to 49 mass %, more preferably from 15 to 40 mass %, even more preferably from 15 to 31 mass % in 100 mass % of the thermoplastic resin composition A. When the thermoplastic resin a is 15 mass % or greater, the dispersed form of the sea-island structure in which the thermoplastic resin a serves as the matrix can be ensured, and steam permeability can be reduced. Further, when the thermoplastic resin a is 49 mass % or less, flexibility can be ensured.

The elastomer a contains at least a butyl elastomer. The elastomer a may be a butyl elastomer by itself or may be a blend with another elastomer. When a butyl elastomer is contained, both low steam permeability and flexibility can be achieved in a compatible manner. The butyl elastomer contained in the elastomer a may be the same as or different from the butyl elastomer contained in an elastomer b. Examples of the butyl elastomer include a butyl rubber, a halogenated butyl rubber, an isobutylene-paramethylstyrene copolymer rubber, a halogenated isobutylene-paramethylstyrene copolymer rubber, and a styrene-isobutylene-styrene block copolymer rubber. Among these, the elastomer a is preferably a halogenated butyl rubber. Examples of the halogenated butyl rubber include a brominated butyl rubber and a chlorinated butyl rubber. When the elastomer a contains the halogenated butyl rubber, the flexibility and the steam permeation resistance of the hose are improved, and additionally, the elastomer is dynamically crosslinked at the time of kneading the thermoplastic resin composition A, resulting in improved durability. The butyl elastomer may be used alone or in a combination of a plurality thereof.

Examples of another elastomer in addition to the butyl elastomer that can be contained in the elastomer a include an olefin elastomer, a styrene elastomer, a urethane elastomer, an ester elastomer, an amide elastomer, and an acrylic elastomer. One or more of these may be blended with the butyl elastomer. Note that, when another elastomer is blended, the amount of the butyl elastomer may be 51 mass % or greater, preferably 75% or greater, and more preferably 95% or greater in 100 mass % of the elastomer a.

The elastomer a is from 51 to 85 mass %, preferably from 60 to 85 mass %, and more preferably from 69 to 85 mass % in 100 mass % of the thermoplastic resin composition A. When the elastomer a is 51 mass % or greater, flexibility can be ensured. In addition, when the elastomer a is 85 mass % or less, the dispersed form of the sea-island structure in which the elastomer a serves as the domains can be ensured, and steam permeability can be reduced, resulting in excellent steam permeability.

In the thermoplastic resin composition A, a part of the domains thereof may be crosslinked. When a part of the domains is crosslinked, the strength of the thermoplastic resin composition A can be increased, and the durability of the outer layer can be further increased. The method for crosslinking a part of the domains is not limited, and examples thereof include dynamic crosslinking by adding a crosslinking agent and melt-kneading the mixture.

The thermoplastic resin composition A forming the outer layer may have a melt viscosity of preferably 1000 Pa·s or less at 250° C. and a shear rate of 243.2 s⁻¹. When the melt viscosity is 1000 Pa·s or less, processability at the time of hose extrusion is improved. In the present specification, the melt viscosity can be measured using a capillary rheometer under predetermined conditions.

The tensile stress at 10% deformation of the thermoplastic resin composition A may be preferably 10 MPa or less, more preferably from 1 to 9 MPa, and even more preferably from 1 to 5 MPa. When the tensile stress at 10% deformation is 10 MPa or less, the outer layer can have excellent flexibility.

The thermoplastic resin composition A has, at room temperature (23° C.), a tensile strength at break of preferably 3 MPa or greater and a tensile elongation at break of preferably 200% or greater. When the tensile strength at break is 3 MPa or greater and the tensile elongation at break is 200% or greater, the durability of the outer layer at room temperature (23° C.) or room temperature (20° C.±15° C.) can be ensured. The tensile strength at break may be more preferably 3.5 MPa or greater, and even more preferably 4 MPa or greater. Further, the tensile elongation at break may be more preferably 250% or greater, and even more preferably 300% or greater.

The thermoplastic resin composition A has a tensile strength at break at 150° C. of preferably 0.4 MPa or greater and a tensile elongation at break at 150° C. of preferably 50% or greater. When the tensile strength at break at 150° C. is 0.4 MPa or greater and the tensile elongation at break at 150° C. is 50% or greater, the durability of the outer layer in a high-temperature state can be ensured. The tensile strength at break at 150° C. may be more preferably 0.5 MPa or greater. Further, the tensile elongation at break at 150° C. may be more preferably 100% or greater, and even more preferably 200% or greater.

In the present specification, the tensile stress at 10% deformation, the tensile strengths at break at 23° C. and 150° C., and the tensile elongations at break at 23° C. and 150° C. can be determined in accordance with the measurement method specified in JIS K6251 “Rubber, vulcanized or thermoplastics—Determination of tensile stress-strain properties”.

The thermoplastic resin composition A preferably has a non-broken Izod impact strength at −40° C., for this can ensure the durability of the outer layer at low temperatures. In the present specification, the Izod impact strength at −40° C. can be measured using a notched test piece in accordance with the measurement method specified in JIS K7110.

The thermoplastic resin composition A preferably has a steam permeability coefficient of 3.0 g·mm/(m²·24 h) or less, more preferably from 1.0 to 3.0 g·mm/(m²·24 h), and even more preferably from 1.0 to 2.0 g·mm/(m²·24 h). When the steam permeability coefficient of the thermoplastic resin composition A is 3.0 g·mm/(m²·24 h) or less, the outer layer can have low, excellent steam permeability. In the present specification, the steam permeability coefficient can be determined by using a sample that is a 0.2-mm-thick sheet made of thermoplastic resin composition at a temperature of 60° C. and a relative humidity of 95%, as described in Examples below.

The thermoplastic resin composition B constituting the inner layer has a sea-island structure in which a thermoplastic resin b serves as the matrix and the elastomer b serves as the domains. The sea-island structure refers to a dispersed form in which the matrix is the sea phase (continuous phase) and the domains are the island phase (discontinuous phase, dispersed phase). The shapes of the domains are not limited, and may be any of a spherical shape, an ellipsoidal shape, a cylindrical shape, an acicular shape, and an amorphous shape. Note that, the dispersed form of the thermoplastic resin composition B can be observed by a scanning probe microscope (SPM) or the like with respect to a vertical cross-section in the extrusion grain direction. The observation magnification can be appropriately determined according to the sizes of the domains.

The thermoplastic resin b contains at least a polyamide resin. The thermoplastic resin b may be a polyamide resin by itself or may be a blend with another thermoplastic resin. When a polyamide resin is contained, oxygen permeability and refrigerant permeability can be reduced, resulting in excellent oxygen permeability and refrigerant permeability. Examples of the polyamide resin include a polyamide 6 resin, a polyamide 66 resin, a polyamide 11 resin, a polyamide 12 resin, a polyamide 610 resin, a polyamide 6/66 copolymer, a polyamide 6/12 copolymer, a polyamide 46 resin, a polyamide 6T resin, a polyamide 9T resin, and a polyamide MXD6 resin. Among these, a polyamide 6 resin is preferred. When the thermoplastic resin b contains a polyamide 6 resin, low refrigerant permeability, low oxygen permeability, and heat resistance can be achieved in a compatible manner. The polyamide resin may be used alone or in a combination of a plurality thereof.

Examples of the other thermoplastic resin in addition to the polyamide resin that can be contained in the thermoplastic resin b include a polyolefin resin, a polyester resin, a polyvinyl alcohol resin, and a polyketone resin. One or more of these may be blended with the polyamide resin. Note that, when the other thermoplastic resin is blended, the polyamide resin may be 51 mass % or greater, preferably 75 mass % or greater, and more preferably 95 mass % or greater in 100 mass % of the thermoplastic resin b.

The thermoplastic resin b preferably contains one or more types of thermoplastic resins having a melting point of 200° C. or higher. When a thermoplastic resin having a melting point of 200° C. or higher is contained, heat resistance can be achieved in a compatible manner. The melting point of the polyamide resin and/or the other thermoplastic resin may be 200° C. or higher, preferably from 200 to 280° C., and more preferably from 210 to 280° C.

The thermoplastic resin b may be preferably from 15 to 49 mass %, more preferably from 15 to 40 mass %, and even more preferably from 20 to 39 mass % in 100 mass % of the thermoplastic resin composition B. When the thermoplastic resin b is 15 mass % or greater, the dispersed form of the sea-island structure in which the thermoplastic resin b serves as the matrix becomes easy to ensure, and refrigerant permeability and oxygen permeability can be reduced. Further, when the thermoplastic resin b is 49 mass % or less, flexibility can be ensured.

The elastomer b contains at least a butyl elastomer. The elastomer b may be a butyl elastomer by itself or may be a blend with another elastomer. When a butyl elastomer is contained, low oxygen permeability, low refrigerant permeability, and flexibility can be achieved in a compatible manner. The butyl elastomer contained in the elastomer b may be the same as or different from the butyl elastomer contained in the elastomer a as described above. Examples of the butyl elastomer include a butyl rubber, a halogenated butyl rubber, an isobutylene-paramethylstyrene copolymer rubber, a halogenated isobutylene-paramethylstyrene copolymer rubber, and a styrene-isobutylene-styrene block copolymer rubber. Among these, the elastomer b is preferably a halogenated isobutylene-paramethylstyrene copolymer rubber. Examples of the halogenated isobutylene-paramethylstyrene copolymer rubber include a brominated isobutylene-paramethylstyrene copolymer rubber and a chlorinated isobutylene-paramethylstyrene copolymer rubber. When the elastomer b contains the halogenated isobutylene-paramethylstyrene copolymer rubber, the flexibility, oxygen permeation resistance, and refrigerant permeation resistance of the hose are improved, and additionally, the elastomer is dynamically crosslinked at the time of kneading the thermoplastic resin composition B, resulting in improved durability. The butyl elastomer may be used alone or in a combination of a plurality thereof.

Examples of another elastomer in addition to the butyl elastomer that can be contained in the elastomer b include an olefin elastomer, a styrene elastomer, a urethane elastomer, an ester elastomer, an amide elastomer, and an acrylic elastomer. One or more of these may be blended with the butyl elastomer. Note that, when another elastomer is blended, the amount of the butyl elastomer may be 51 mass % or greater, preferably 75% or greater, and more preferably 95% or greater in 100 mass % of the elastomer b.

The elastomer b is preferably from 51 to 85 mass %, and more preferably from 60 to 85 mass % in 100 mass % of the thermoplastic resin composition B. When the elastomer b is 51 mass % or greater, flexibility can be ensured. In addition, when the elastomer b is 85 mass % or less, the dispersed form of the sea-island structure in which the elastomer b serves as the domains can be ensured, and refrigerant permeability and oxygen permeability can be reduced, resulting in excellent refrigerant permeability and oxygen permeability.

In the thermoplastic resin composition B, a part of the domains thereof may be crosslinked. When a part of the domains is crosslinked, the strength of the thermoplastic resin composition B can be increased, and the durability of the inner layer can be further increased. The method for crosslinking a part of the domains is not limited, and examples thereof include dynamic crosslinking by adding a crosslinking agent and melt-kneading the mixture.

The tensile stress at 10% deformation of the thermoplastic resin composition B may be preferably 10 MPa or less, more preferably from 1 to 9 MPa, and even more preferably from 1 to 7 MPa. When the tensile stress at 10% deformation is 10 MPa or less, the inner layer can have excellent flexibility. Further, the thermoplastic resin composition B preferably has a non-broken Izod impact strength at −40° C., for this can ensure the durability of the inner layer at low temperatures.

The thermoplastic resin composition B preferably has an oxygen permeability coefficient of 0.05 cm³·mm/(m²·day·mmHg) or less, more preferably from 0.0001 to 0.02 cm³·mm/(m²·day·mmHg), and even more preferably from 0.0001 to 0.01 cm³·mm/(m²·day·mmHg). When the oxygen permeability coefficient of the thermoplastic resin composition B is 0.05 cm³·mm/(m²·day·mmHg) or less, the inner layer can have low, excellent oxygen permeability while the permeability of refrigerant can be reduced. In the present specification, the oxygen permeability coefficient can be determined by using a sample that is a 0.2-mm-thick sheet made of thermoplastic resin composition under the conditions of 21° C. and 50 RH %, as described in Examples below.

The fluorocarbon permeability coefficient of the thermoplastic resin composition B is preferably smaller than the fluorocarbon permeability coefficient of the thermoplastic resin composition A. This allows the permeability of fluorocarbons transported by the hose to be efficiently reduced, suppressing the occurrence of blisters. Therefore, the fluorocarbon permeability coefficient of a thermoplastic resin composition for outer layer may be larger than the fluorocarbon permeability coefficient of a thermoplastic resin composition for inner layer, and the ratio of the fluorocarbon permeability coefficient of the thermoplastic resin composition for outer layer to the fluorocarbon permeability coefficient of the thermoplastic resin composition for inner layer, or [outer layer/inner layer], is preferably 1.0 or greater, and more preferably 10 or greater. In the present specification, the fluorocarbon permeability coefficient can be determined from the amount of permeation at 80° C. and 72 hours using a sample that is a 0.2-mm-thick sheet made of thermoplastic resin composition and using a fluorocarbon HFO-1234yf, as described in Examples below.

Meanwhile, the steam permeability coefficient of the thermoplastic resin composition A may be smaller than the steam permeability coefficient of the thermoplastic resin composition B. This can suppress the permeation and diffusion of moisture from the outside of the hose, prevent moisture absorption by the inner layer containing a polyamide resin, and maintain a low permeability of fluorocarbons. Therefore, the fluorocarbon permeability coefficient of the thermoplastic resin composition for outer layer may be smaller than the fluorocarbon permeability coefficient of the thermoplastic resin composition for inner layer, and the ratio of the fluorocarbon permeability coefficient of the thermoplastic resin composition for outer layer to the fluorocarbon permeability coefficient of the thermoplastic resin composition for inner layer or [outer layer/inner layer], is preferably less than 1.0, and more preferably 0.4 or less.

The refrigerant-transporting hose includes at least an outer layer having the layer composed of the thermoplastic resin composition A, a reinforcing layer, and an inner layer having the layer composed of the thermoplastic resin composition B. The outer diameter of the refrigerant-transporting hose is not limited but may be, for example, from 4 to 30 mm. The inner diameter of the refrigerant-transporting hose is not limited but may be, for example, from 3 to 25 mm.

The outer layer may be configured to have only the layer composed of the thermoplastic resin composition A, or may be layered with another layer. The thickness of the outer layer is not limited but may be, for example, from 0.5 to 4 mm.

The inner layer may be configured to have only the layer composed of the thermoplastic resin composition B, or may be layered with another layer. The thickness of the inner layer is not limited but may be, for example, from 0.2 to 3 mm.

The refrigerant-transporting hose has the reinforcing layer between the outer layer and the inner layer. When the reinforcing layer is contained, the strength of the hose can be ensured, resulting in excellent pressure resistance. The thickness of the reinforcing layer is not limited but may be, for example, from 0.3 to 3 mm.

The reinforcing material that can form the reinforcing layer is not limited, and may be either an organic material or an inorganic material. For example, the organic material may be a polymer (fiber material), such as polyester, polyamide, aramid, vinylon, rayon, PBO (polyparaphenylene benzobisoxazole), polyketone, and polyarylate. Further, examples of the inorganic material include a metal, such as a hard steel wire that is exemplified by a brass-plated wire and a galvanized wire. The reinforcing material may be surface-treated. From the perspective of achieving excellent fatigue resistance performance and excellent cost performance, the reinforcing layer is preferably polyester fiber.

Preferred examples of the form of the reinforcing layer (reinforcing material) include those braided into a spiral structure and/or a braid structure. Further, the reinforcing layer may be either a single reinforcing layer or a plurality of reinforcing layers.

In the refrigerant-transporting hose, an adhesive layer may be interposed between the outer layer and the reinforcing layer and/or between the inner layer and the reinforcing layer. The adhesive layer can further increase the durability of the hose. The adhesive layer may be composed of, for example, a water-based adhesive, a solvent-based adhesive, a chemical reaction adhesive, or a hot-melt adhesive.

The refrigerant-transporting hose may have the adhesive layer, a barrier layer, a rubber layer, or the like as a layer in addition to the outer layer, the reinforcing layer and the inner layer, but preferably does not have a layer composed of vulcanized rubber. When a layer composed of vulcanized rubber is not provided, a vulcanization step can be omitted and the man-hours for manufacturing the refrigerant-transporting hose can be reduced, resulting in improved productivity.

The moisture permeation amount of the refrigerant-transporting hose is preferably 1.5 mg/(cm²·240 h) or less, more preferably 1.3 mg/(cm²·240 h). When the moisture permeation amount of the refrigerant-transporting hose is 1.5 mg/(cm²·240 h) or less, permeation and diffusion of moisture in the air and/or steam into the inside of the hose can be suppressed, moisture absorption by the inner layer containing a polyamide resin can be prevented, and a low permeability of fluorocarbons can be maintained. In the present specification, the moisture permeation amount of the refrigerant-transporting hose refers to the mass (mg) of steam that permeates from the outer surface to the inner surface during 240 hours per 1 cm² of the inner surface area of the hose under conditions of a temperature of 50° C. and a relative humidity of 95%. The moisture permeation amount of the refrigerant-transporting hose was calculated as follows. A refrigerant-transporting hose that is filled with a weighed amount of a drying agent and that has its opening portions sealed was left in an atmosphere with a temperature of 50° C. and a relative humidity of 95%, and the amount of increase in the mass of the drying agent from 120 hours later to 360 hours later was measured. Then, the moisture permeation amount (mg/(240 h·cm²)) was calculated by dividing the amount of increase in the mass during 240 hours by the inner surface area of test sample.

The refrigerant-transporting hose has a fluorocarbon HFO-1234yf permeation amount (hereinafter sometimes referred to as “refrigerant permeation amount”) of preferably 10 kg/(m²·year) or less, more preferably 3.0 kg/(m²·year) or less. When the refrigerant permeation amount of the refrigerant-transporting hose is 3.0 kg/(m²·year) or less, the fluorocarbons to be transported can be prevented from permeating and diffusing, and in turn, escaping to the outside. In the present specification, the refrigerant permeation amount of the refrigerant-transporting hose refers to the mass (kg) of refrigerant permeating from the inner surface to the outer surface during one year (8760 hours) per 1 m² of the surface area of the inner circumferential surface of the hose under the condition of 80° C. The refrigerant permeation amount of the refrigerant-transporting hose was measured in accordance with SAE J2064 AUG2015. Test samples having a length of 1.07 m were filled with a refrigerant (HFO-1234yf) at an amount of 70%±3% per 1 cm³ of the internal volume of the test sample. The test samples were left under an atmosphere of 80° C. for 25 days, and the amount of decrease in mass (refrigerant permeation amount) in the last predetermined period (from 5 days to 7 days) during the 25-day period was measured. Then, the refrigerant permeation amount (kg/(m²·year)) was obtained by dividing the amount of decrease by the inner surface area of test sample and subjecting the resulting value to unit conversion.

The method of manufacturing the refrigerant-transporting hose is not limited, and examples thereof include a manufacturing method including extruding the prepared thermoplastic resin composition B into a circular tube shape by extrusion molding to form the inner layer, forming the reinforcing layer, and optionally, the adhesive layer, at the outer circumferential surface of the inner layer, and extruding the prepared thermoplastic resin composition A into a circular tube shape by extrusion molding to form the outer layer at the outer circumferential surface of the previously formed layer.

Embodiments according to the present invention are further described below by Examples. However, the scope of the present invention is not limited to these Examples.

### EXAMPLE

The thermoplastic resin compositions A and the thermoplastic resin compositions B described in Tables 1 to 2 were prepared by the following method. First, butyl rubber was processed into a pellet shape using a rubber pelletizer (available from Moriyama MFG. Co., Ltd.). In preparing thermoplastic resin compositions (A-1 to A-5, A′-6 to A′-8, B-1, B′-2 to B′-3) having the compounding proportions presented in Tables 1 and 2, raw materials were charged into a twin screw extruder (available from The Japan Steel Works, Ltd.) at the compounding ratios presented in Tables 1 to 2, and kneaded for 3 minutes at 235° C. The kneaded products were extruded continuously in a strand-like form from the extruder, cooled with water, and then cut with a cutter, resulting in thermoplastic resin compositions A and thermoplastic resin compositions B having a pellet shaped. Dynamic crosslinking takes place in the twin screw extruder.

The resulting pellets of the thermoplastic resin compositions for the inner layer and the outer layer were formed into sheets with an average thickness of 0.2 mm and sheets with an average thickness of 2 mm by using a 40 mm Ø single screw extruder (available from Pla Giken Co., Ltd.) equipped with a 200-mm wide T-shaped die, with the temperatures of the cylinder and the die set to 10° C. higher than the melting points of the components having the highest melting point among all components in the thermoplastic resin compositions, and at a cooling roll temperature of 50° C. and a take-up speed of 3 m/min. The sheets with a thickness of 0.2 mm were cut and subjected to measurements of steam permeability coefficient, oxygen permeability coefficient, fluorocarbon permeability coefficient, tensile stress, tensile strengths at break at 23° C. and 150° C., and tensile elongations at break at 23° C. and 150° C. Further, the sheets with a thickness of 2 mm were subjected to measurements of Izod impact strength at −40° C.

The pellets of the thermoplastic resin composition B for the inner layer described above were extruded onto a mandrel coated with a release agent in advance to form an inner layer with a circular tube shape having a thickness of 0.8 mm by using a 40 mm Ø single screw extruder (available from Pla Giken Co., Ltd.) equipped with a die having an annular slit, with the temperatures of the cylinder and the die set to 10° C. higher than the melting point of the component having the highest melting point among all components in the thermoplastic resin composition B. An adhesive was applied to the outer circumference of the resulting inner layer while polyester fiber was braided using a braiding machine to form a reinforcing layer, and then an adhesive was further applied. Then, the pellets of the thermoplastic resin composition A for outer layer described above were subjected to extrusion molding to form an outer layer with a circular tube shape having a thickness of 0.4 mm at the outer circumference of the reinforcing layer by using a 40 mm 0 single screw extruder (available from Pla Giken Co., Ltd.) equipped with a die having an annular slit, with the temperatures of the cylinder and the die set to 10° C. higher than the melting point of the component having the highest melting point among all components in the thermoplastic resin composition A. The mandrel was removed, resulting in refrigerant-transporting hoses including the inner layers, the reinforcing layers, and the outer layers (Examples 1 to 7 and Comparative Examples 1 to 3). Note that none of the refrigerant-transporting hoses has a layer composed of vulcanized rubber.

The resulting refrigerant-transporting hoses were subjected to measurements of the presence of blisters, as well as the refrigerant permeation amount and the moisture permeation amount.

Further, the characteristics of the thermoplastic resin compositions for the inner layer and the outer layer and of the refrigerant-transporting hoses were measured by the following methods.

### (1) Melt Viscosities of Thermoplastic Resin Compositions for Outer Layer

The thermoplastic resin compositions were pre-dried at 100° C. for 4 hours, and the melt viscosities (Pa. S) were measured by detecting a load under the conditions of a temperature of 250° C. and a shear rate of 243.2 s⁻¹ using a capillary rheometer (available from Toyo Seiki Seisaku-sho, Ltd.) and using a capillary with a length of 10 mm and an inner diameter of 1 mm. The results are presented in Table 1.

### (2) Steam Permeability Coefficients of Thermoplastic Resin Compositions for Inner Layer and Outer Layer

The 0.2-mm-thick sheets of the thermoplastic resin compositions obtained above were subjected to measurements of steam permeability coefficient (unit: g·mm/(m²·24 h)) by using a steam permeation tester available from GTR Tec Corporation under the conditions of a temperature of 60° C. and a relative humidity of 95%. The steam permeability coefficients of the thermoplastic resin compositions for outer layer are presented in Table 1. The ratio of the steam permeability coefficient of thermoplastic resin composition for inner layer to the steam permeability coefficient of thermoplastic resin composition for outer layer was calculated as [outer layer/inner layer]. The ratios [outer layer/inner layer] are listed in Tables 3 and 4 as “excellent” when the ratio was 0.4 or less, “good” when the ratio was greater than 0.4 and less than 1.0, and “poor” when the ratio was 1.0 or greater.

### (3) Oxygen Permeability Coefficients of Thermoplastic Resin Compositions for Inner Layer and Outer Layer

The 0.2-mm-thick sheets of the thermoplastic resin compositions obtained above were subjected to measurements of oxygen permeability coefficient (unit: cm³·mm/(m²·day·mmHg)) by using OXTRAN 1/50 available from MOCON under the conditions of a temperature of 21° C. and a relative humidity of 50%. The oxygen permeability coefficients of the thermoplastic resin compositions for outer layer are presented in Table 1, and the oxygen permeability coefficients of the thermoplastic resin compositions for the inner layer are presented in Table 2.

### (4) Fluorocarbon Permeability Coefficients of Thermoplastic Resin Compositions for Inner Layer and Outer Layer

The 0.2-mm-thick sheets of the thermoplastic resin compositions obtained above (hereinafter referred to as “sample sheets”) were subjected to measurements of fluorocarbon permeability coefficient using the fluorocarbon HFO-1234yf. The fluorocarbon HFO-1234yf was placed into a stainless steel cup up to half of the cup capacity. The opening portion of the cup was covered and sealed with the sample sheet using a predetermined jig. In this state, a static test was performed at a temperature of 80° C. for 72 hours. The mass of the cup sealed with the sample sheet was measured before and after the static test to calculate the weight of the fluorocarbon decreased, and the fluorocarbon permeability coefficient (unit: g·mm/(72h·cm²)) was calculated. Using the calculated results, the ratio of the fluorocarbon permeability coefficient of thermoplastic resin composition for inner layer to the fluorocarbon permeability coefficient of thermoplastic resin composition for outer layer was calculated as [outer layer/inner layer]. The ratios [outer layer/inner layer] are presented in Tables 3 and 4 as “excellent” when the ratio was greater than 10, “good” when the ratio was greater than 1.0 and 10 or less, and “poor” when the ratio was 1.0 or less.

### (5) Tensile Test Characteristics of Thermoplastic Resin Compositions for Inner Layer and Outer Layer

The 0.2-mm-thick sheets of the thermoplastic resin compositions obtained above were punched into a JIS No. 3 dumbbell shape and subjected to tensile tests at 23° C. and 150° C. at a tensile speed of 500 mm/min in accordance with the measurement method specified in JIS K6251 “Rubber, vulcanized or thermoplastics—Determination of tensile stress-strain properties”. From the resulting stress-strain curves, tensile stress at 10% deformation at 23° C., tensile strength at break at 23° C., tensile elongation at break at 23° C., as well as tensile strength at break at 150° C. and tensile elongation at break at 150° C. were measured. The results are presented in Tables 1 and 2.

### (6) Izod Test Characteristics of Thermoplastic Resin Compositions for Inner Layer and Outer Layer

The 2-mm-thick sheets of the thermoplastic resin compositions obtained above were processed into notched test pieces having a length of 63.5 mm, a width of 10 mm, and a thickness of 2 mm in accordance with JIS K7110, and subjected to an Izod impact test at −40° C. The results are presented in Tables 1 and 2. Note that, “NB” was noted in the table for the notched test pieces that were not broken even after being subjected to an Izod impact test.

### (7) Blisters of Refrigerant-Transporting Hoses

The refrigerant-transporting hoses obtained as above were observed and evaluated for the presence of blisters. The results are presented in Tables 3 and 4.

### (8) Flexibilities of Refrigerant-Transporting Hoses

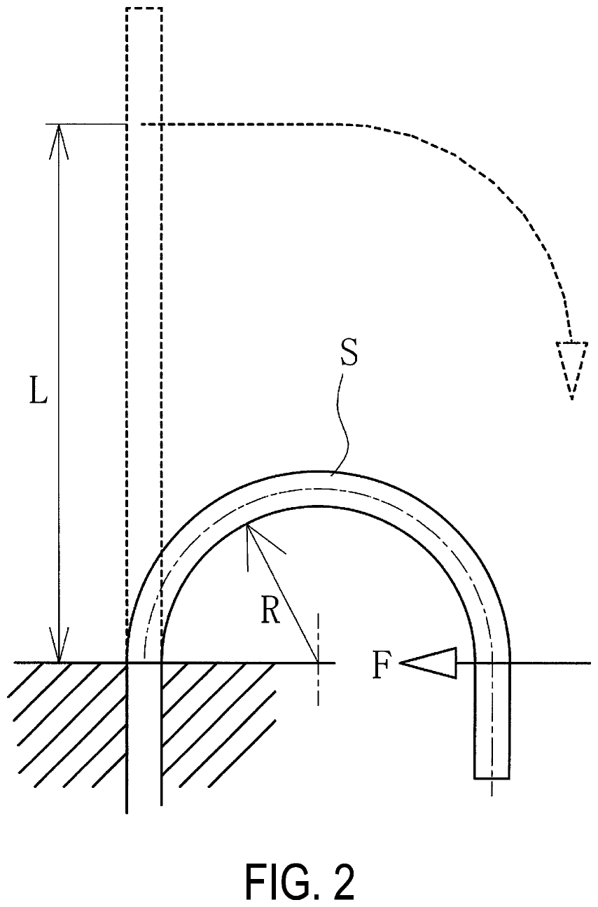

As illustrated in FIG. 2, one end of the refrigerant-transporting hose in the longitudinal direction was fixed by a fixing tool such as a clamp, and a spring scale was attached at a position separated from the fixing position by a predetermined length L ((120+hose outer diameter/2)×π [mm]) and pulled to bend the refrigerant-transporting hose to a semicircular arc-shape, resulting in the refrigerant-transporting hose to change from the state illustrated by a dashed line to the state illustrated by a solid line. Then, the tensile force F (unit: N) when the refrigerant-transporting hose was in a bent state with the hose inner side radius R being 120 mm was measured by the spring scale pulling horizontally. The obtained results are presented in Tables 3 and 4 with the value of Comparative Example 1 expressed as an index of 100. Note that, the hose of Comparative Example 3 was not evaluated because the thicknesses of the inner layer and the outer layer were different from those of the other hoses.

### (9) Refrigerant Permeation Amounts of Refrigerant-Transporting Hoses

The refrigerant permeation amounts of the refrigerant-transporting hoses were measured in accordance with SAE J2064 AUG2015. The refrigerant-transporting hoses were cut to a length of 1.07 m, resulting in test samples. Then, the test samples were filled with refrigerants (fluorocarbon HFO-1234yf) at an amount of 70%±3% per 1 cm³ of the internal volume of the test samples. The test samples were left in an atmosphere of 80° C. for 25 days, and the amount of decrease in mass (refrigerant permeation amount) per day (24 hours) in the last predetermined period (from 5 days to 7 days) during the 25-day period was measured. The refrigerant permeation amounts (unit: kg/(m²·year)) per year (8760 hours) of the refrigerant-transporting hoses were calculated by dividing the amounts of decrease by the inner surface areas of test samples. The smaller the value of the refrigerant permeation amount, the better the refrigerant permeation resistance. When the refrigerant permeation amount is 3 kg/(m²·year) or less, it can be evaluated that the refrigerant permeation resistance is practically sufficient. The obtained results are listed in Tables 3 and 4 as “excellent” when the refrigerant permeation amount was 3.0 kg/(m²·year) or less, “good” when the refrigerant permeation amount was greater than 3.0 kg/(m²·year) and 10 kg/(m²·year) or less, and “poor” when the refrigerant permeation amount was greater than 10 kg/(m²·year).

### (10) Moisture Permeation Amounts of Refrigerant-Transporting Hoses

The refrigerant-transporting hoses were left in an oven at 50° C. for 5 hours. Then, the test samples were filled with a drying agent in a volume corresponding to 80% of the internal volume and were sealed. The test samples were left in an atmosphere of 50° C. and a relative humidity of 95 RH %. Then, the amounts of increase in the mass of the drying agent from 120 hours later to 360 hours later were measured. The moisture permeation amounts of the refrigerant-transporting hoses (unit: mg/(cm²·240 h)) were calculated by dividing the measured amounts of increase in mass during 240 hours (unit: mg) by the inner surface area of test sample (unit: cm²). The obtained results are listed in Tables 3 and 4 as excellent when the moisture permeation amount was 1.3 mg/(cm₂·240 h) or less, good when the moisture permeation amount was greater than 1.3 mg/(cm²·240 h) and 1.5 mg/(cm²·240 h) or less, and poor when the moisture permeation amount was greater than 1.5 mg/(cm²·240 h).

TABLE 1

| | | Thermoplastic resin composition constituting outer layer | | | | | | | |
|---|---|---|---|---|---|---|---|---|---|
| | | A-1 | A-2 | A-3 | A-4 | A-5 | A′-6 | A′-7 | A′-8 |
| Resin a-1 | Mass % | 29 | | 17 | 47 | | 53 | | |
| Resin a-2 | Mass % | | | | | 29 | | | |
| Resin a-3 | Mass % | | 29 | | | | | | |
| Resin b-1 | Mass % | | | | | | | | 24 |
| Resin b-2 | Mass % | | | | | | | 32.6 | |
| Resin b-3 | Mass % | | | | | | | | 10 |
| Elastomer a | Mass % | 69 | 69 | 81 | 51 | 69 | 45 | | |
| Elastomer b | Mass % | | | | | | | 61.3 | 60 |
| Zinc oxide | Mass % | 2 | 2 | 2 | 2 | 2 | 2 | 3.1 | 1.2 |
| Crosslinking | Mass % | | | | | | | 2.1 | 3 |
| agent | | | | | | | | | |
| Viscosity | Mass % | | | | | | | 0.9 | 1.8 |
| stabilizer | | | | | | | | | |

| | | | | | | | | |
|---|---|---|---|---|---|---|---|---|
| Melt | 303 | 303 | 450 | 290 | 303 | 280 | 1194 | 1113 |
| viscosity (Pa · s) | | | | | | | | |
| Tensile stress | 4.0 | 3.9 | 2.5 | 9.7 | 3.8 | 10.0 | 5.0 | 6.0 |
| at 10% (MPa) | | | | | | | | |
| Steam permeability | 1.7 | 1.8 | 1.6 | 2.1 | 1.8 | 2.1 | 2.8 | 5.0 |
| coefficient | | | | | | | | |
| (g · mm/(m² · 24 h)) | | | | | | | | |
| Oxygen permeability | 0.1108 | 0.1121 | 0.1001 | 0.1211 | 0.1209 | 0.1223 | 0.0529 | 0.007 |
| coefficient | | | | | | | | |
| (cm³ · mm/ | | | | | | | | |
| (m² · day · mmHg)) | | | | | | | | |
| Tensile | 6.5 | 6.5 | 3.2 | 10.0 | 4.2 | 11.0 | 20.0 | 29.0 |
| strength at | | | | | | | | |
| break (MPa) | | | | | | | | |
| Tensile | 502 | 502 | 605 | 210 | 594 | 201 | 410 | 400 |
| elongation at (%) | | | | | | | | |
| break | | | | | | | | |
| Tensile strength at | 0.5 | 0.5 | 0.5 | 0.5 | 0.4 | 0.4 | 5.8 | 19.0 |
| break (150° C.) (MPa) | | | | | | | | |
| Tensile elongation at | 800 | 800 | 821 | 60 | 100 | 115 | 330 | 420 |
| break (150° C.) (%) | | | | | | | | |
| Izod test (−40° C.) (—) | NB | NB | NB | NB | NB | NB | NB | NB |

TABLE 2

| | | Thermoplastic resin composition | | |
|---|---|---|---|---|
| | | constituting inner layer | | |
| | | B-1 | B′-2 | B′-3 |
| Resin b-1 | Mass % | 24 | 36 | |
| Resin b-3 | Mass % | 10 | 14 | |
| Resin a-1 | Mass % | | | 29 |
| Elastomer b | Mass % | 60 | 45 | |
| Elastomer a | Mass % | | | 69 |
| Crosslinking agent | Mass % | 1.2 | 0.8 | |
| Zinc oxide | Mass % | 3 | 3 | 2 |
| Viscosity stabilizer | Mass % | 1.8 | 1.2 | |

| | | | |
|---|---|---|---|
| Oxygen permeability coefficient | 0.007 | 0.005 | 0.1108 |
| (cm³ · mm/(m² · day · mmHg)) | | | |
| Tensile stress at 10% (MPa) | 6.0 | 10.0 | 4.0 |
| Izod test (−40° C.) (—) | NB | NB | NB |

Types of raw materials used as indicated in Tables 1 and 2 are described below.
Resin a-1: propylene homopolymer, Prime Polypro J108M available from Prime Polymer Co., Ltd., melting point of 165° C.
Resin a-2: propylene/ethylene random copolymer, Novatec MG05ES available from Japan Polypropylene Corporation, melting point of 147° C.
Resin a-3: propylene/ethylene block copolymer, Novatec BC06C available from Japan Polypropylene Corporation, melting point of 165° C.
Resin b-1: polyamide 6, nylon 6 “UBE Nylon” 1011FB available from Ube Industries, Ltd., melting point of 225° C.
Resin b-2: polyamide 12, nylon 12 “UBESTA” (trade name) 3012U available from Ube Industries, Ltd., melting point of 176° C.
Resin b-3: polyamide 612, nylon 6/12 copolymer “UBE Nylon” 7024B available from Ube Industries, Ltd., melting point of 201° C.
Elastomer a: brominated butyl rubber, “Exxon Bromobutyl 2255” available from ExxonMobile Chemical Co.
Elastomer b: brominated isobutylene-paramethylstyrene copolymer rubber, “EXXPRO” (trade name) 3745, available from ExxonMobile Chemical Co.
Zinc oxide: Zinc Oxide III, available from Seido Chemical Industry Co., Ltd.
Crosslinking agent: N-phenyl-N′-(1,3-dimethylbutyl)-p-phenylenediamine “SANTOFLEX” (trade name) 6PPD available from Solutia Inc.
Viscosity stabilizer: calcium stearate, calcium stearate SC-PG available from Sakai Chemical Industry Co., Ltd.

TABLE 3

| | Example | Example | Example | Example | Example | Example | Example |
|---|---|---|---|---|---|---|---|
| | 1 | 2 | 3 | 4 | 5 | 6 | 7 |
| Resin | A-1 | A-1 | A-2 | A-3 | A-4 | A-5 | A-1 |
| composition | | | | | | | |
| constituting | | | | | | | |
| outer layer | | | | | | | |
| Thickness of | 0.4 | 0.4 | 0.4 | 0.4 | 0.4 | 0.4 | 0.4 |
| outer layer | | | | | | | |
| (mm) | | | | | | | |
| Adhesive | Adhesive-1 | Adhesive-2 | Adhesive-1 | Adhesive-1 | Adhesive-1 | Adhesive-1 | Adhesive-1 |
| between outer | | | | | | | |
| layer/reinforcing | | | | | | | |
| layer | | | | | | | |
| Composition of | PET fiber | PET fiber | PET fiber | PET fiber | PET fiber | PET fiber | PET fiber |
| reinforcing | | | | | | | |
| layer | | | | | | | |
| Adhesive | Adhesive-2 | Adhesive-2 | Adhesive-2 | Adhesive-2 | Adhesive-2 | Adhesive-2 | Adhesive-2 |
| between inner | | | | | | | |
| layer/reinforcing | | | | | | | |
| layer | | | | | | | |
| Resin | B-1 | B-1 | B-1 | B-1 | B-1 | B-1 | B′-2 |
| composition | | | | | | | |
| constituting | | | | | | | |
| inner layer | | | | | | | |
| Thickness of | 0.8 | 0.8 | 0.8 | 0.8 | 0.8 | 0.8 | 0.8 |
| inner layer | | | | | | | |
| (mm) | | | | | | | |
| Presence of | No | No | No | No | No | No | No |
| blisters | | | | | | | |
| Hose | 72 | 72 | 72 | 66 | 97 | 71 | 98 |
| flexibility | | | | | | | |
| (index value) | | | | | | | |
| Ratio of | Excellent | Excellent | Excellent | Excellent | Excellent | Excellent | Excellent |
| fluorocarbon | | | | | | | |
| permeability | | | | | | | |
| coefficient | | | | | | | |
| [outer | | | | | | | |
| layer/inner | | | | | | | |
| layer] | | | | | | | |
| Refrigerant | Excellent | Excellent | Excellent | Excellent | Excellent | Excellent | Excellent |
| permeation | | | | | | | |
| amount | | | | | | | |
| Ratio of steam | Excellent | Excellent | Excellent | Excellent | Good | Excellent | Excellent |
| permeability | | | | | | | |
| coefficient | | | | | | | |
| [outer | | | | | | | |
| layer/inner | | | | | | | |
| layer] | | | | | | | |
| Moisture | Excellent | Excellent | Excellent | Excellent | Excellent | Excellent | Good |
| permeation | | | | | | | |
| amount | | | | | | | |

TABLE 4

| | Comparative | Comparative | Comparative |
|---|---|---|---|
| | Example 1 | Example 2 | Example 3 |
| Resin composition | A′-6 | A′-7 | A′-8 |
| constituting outer layer | | | |
| Thickness of outer layer | 0.4 | 0.4 | 0.8 |
| (mm) | | | |
| Adhesive between outer | Adhesive-1 | Adhesive-2 | Adhesive-2 |
| layer/reinforcing layer | | | |
| Composition of reinforcing | PET fiber | PET fiber | PET fiber |
| layer | | | |
| Adhesive between inner | Adhesive-2 | Adhesive-2 | Adhesive-1 |
| layer/reinforcing layer | | | |
| Resin composition | B-1 | B-1 | B′-3 |
| constituting inner layer | | | |
| Thickness of inner layer | 0.8 | 0.8 | 0.4 |
| (mm) | | | |
| Presence of blisters | No | No | Yes |
| Hose flexibility (index | 100 | 77 | — |
| value) | | | |
| Ratio of fluorocarbon | Excellent | Good | Poor |
| permeability coefficient | | | |
| [outer layer/inner layer] | | | |
| Refrigerant permeation | Excellent | Excellent | Poor |
| amount | | | |
| Ratio of steam permeability | Good | Good | Poor |
| coefficient [outer layer/inner | | | |
| layer] | | | |
| Moisture permeation amount | Good | Poor | Excellent |

Types of raw materials used as indicated in Tables 3 and 4 are described below.
Thermoplastic resin compositions A-1 to A-5, A′-6 to A′-8 constituting outer layer: see Table 1
PET fiber: polyethylene terephthalate fiber
Adhesive-1: acid-modified polyolefin adhesive
Adhesive-2: moisture curing urethane adhesive
Thermoplastic resin compositions B-1, B′-2, B′-3 constituting inner layer: see Table 2

As can be seen from Table 3, it was confirmed that the refrigerant-transporting hoses of Examples 1 to 7 had low steam permeability and low fluorocarbon permeability, and that the hoses were flexible and light weight. Note that, in the refrigerant-transporting hose of Example 7, the resin composition (B′-2) constituting the inner layer contains the elastomer b in an amount of less than 51 mass %, and as such the effect of enhancing the flexibility of the hose tends to be slightly small.

As can be seen from Table 4, in the refrigerant-transporting hose of Comparative Example 1, the elastomer a is less than 51 mass % in the resin composition (A′-6) constituting the outer layer, and as such the flexibility of the hose is inferior to that of Examples 1 to 7.

In the refrigerant-transporting hose of Comparative Example 2, the thermoplastic resin a in the resin composition (A′-7) constituting the outer layer contains a polyamide resin instead of a polyolefin resin, resulting in poor steam transmission.

In the refrigerant-transporting hose of Comparative Example 3, the thermoplastic resin a in the resin composition (A′-8) constituting the outer layer contains a polyamide resin instead of a polyolefin resin, and the thermoplastic resin b in the resin composition (B′-3) constituting the inner layer contains a polyolefin resin instead of a polyamide resin, resulting in poor refrigerant permeation amount.

### REFERENCE SIGNS LIST

1 Refrigerant-transporting hose
2 Inner layer
3 Reinforcing layer
4 Outer layer

1. A refrigerant-transporting hose comprising at least an outer layer, a reinforcing layer, and an inner layer,
the outer layer comprising at least a layer composed of a thermoplastic resin composition A and the inner layer comprising at least a layer composed of a thermoplastic resin composition B,
the thermoplastic resin composition A having a sea-island structure in which a thermoplastic resin a serves as a matrix and an elastomer a serves as domains, the thermoplastic resin a comprising at least a polyolefin resin, and the elastomer a comprising at least a butyl elastomer, the elastomer a being from 51 to 85 mass % in 100 mass % of the thermoplastic resin composition A,
the thermoplastic resin composition B having a sea-island structure in which a thermoplastic resin b serves as a matrix and an elastomer b serves as domains, the thermoplastic resin b comprising at least a polyamide resin, and the elastomer b comprising at least a butyl elastomer.

2. The refrigerant-transporting hose according to claim 1, wherein the elastomer b is from 51 to 85 mass % in 100 mass % of the thermoplastic resin composition B.

3. The refrigerant-transporting hose according to claim 1, wherein the refrigerant-transporting hose does not comprise a layer composed of vulcanized rubber.

4. The refrigerant-transporting hose according to claim 1, wherein a fluorocarbon permeability coefficient of the thermoplastic resin composition B is smaller than a fluorocarbon permeability coefficient of the thermoplastic resin composition A.

5. The refrigerant-transporting hose according to claim 1, wherein a steam permeability coefficient of the thermoplastic resin composition A is smaller than a steam permeability coefficient of the thermoplastic resin composition B.

6. The refrigerant-transporting hose according to claim 1, wherein the thermoplastic resin a comprises at least a polypropylene resin, and the elastomer a comprises at least a halogenated butyl rubber.

7. The refrigerant-transporting hose according to claim 1, wherein the thermoplastic resin b comprises at least a polyamide 6 resin, and the elastomer b comprises at least a halogenated isobutylene-paramethylstyrene copolymer rubber.

8. The refrigerant-transporting hose according to claim 1, wherein a part of the domains of the thermoplastic resin composition A and/or a part of the domains of the thermoplastic resin composition B is crosslinked.

9. The refrigerant-transporting hose according to claim 1, wherein a water-based adhesive, a solvent-based adhesive, a chemical reaction adhesive, or a hot-melt adhesive is interposed between the outer layer and the reinforcing layer and/or between the inner layer and the reinforcing layer.

10. The refrigerant-transporting hose according to claim 1, wherein the thermoplastic resin composition A has a melt viscosity of 1000 Pa·s or less at 250° C. and a shear rate of 243.2 s⁻¹.

11. The refrigerant-transporting hose according to claim 1, wherein the thermoplastic resin a comprises one or more types of thermoplastic resins having a melting point of 150° C. or higher, and the thermoplastic resin b comprises one or more types of thermoplastic resins having a melting point of 200° C. or higher.

12. The refrigerant-transporting hose according to claim 1, wherein the thermoplastic resin composition A has a tensile stress at 10% deformation of 10 MPa or less and a steam permeability coefficient of 3.0 g·mm/(m²·24 h) or less.

13. The refrigerant-transporting hose according to claim 1, wherein the thermoplastic resin composition B has a tensile stress at 10% deformation of 10 MPa or less and an oxygen permeability coefficient of 0.05 cm³·mm/(m²·day·mmHg) or less.

14. The refrigerant-transporting hose according to claim 1, wherein the thermoplastic resin composition A has a tensile strength at break at 23° C. of 3 MPa or greater and a tensile elongation at break of 200% or greater.

15. The refrigerant-transporting hose according to claim 1, wherein the thermoplastic resin composition A has a tensile strength at break at 150° C. of 0.4 MPa or greater and a tensile elongation at break at 150° C. of 50% or greater.

16. The refrigerant-transporting hose according to claim 1, wherein the thermoplastic resin composition A and the thermoplastic resin composition B have a non-broken Izod impact strength at −40° C.
